(19) United States
(12) Patent Application Publication
(10) Pub. No.: US 2012/0056823 A1
(43) Pub. Date: Mar. 8, 2012

(54) Gesture-Based Addressing of Devices

(75) Inventors: Robert Skog, Hasselby (SE); Mats Cedervall, Harnosand (SE); Justus Petersson, Stockholm (SE)

(73) Assignee: TELEFONAKTIEBOLAGET L M ERICSSON (PUBL), Stockholm (SE)

(21) Appl. No.: 12/877,206

(22) Filed: Sep. 8, 2010

(51) Int. Cl. G06F 3/041

(52) U.S. Cl. 345/173

(57) ABSTRACT

A method of selecting and controlling an electronic device by gestures on a remote control includes determining a number of fingers touching a screen of the remote control; based on the number determined, setting an address context corresponding to the electronic device; identifying a gesture made by the fingers on the screen; and based on the gesture identified, generating a corresponding command to be sent to the electronic device corresponding to the set address context.

### TECHNICAL FIELD

This invention relates to remotely controllable electronic devices and more particularly to wireless touch-screen devices for remotely controlling electronic devices.

### BACKGROUND

Today's homes and offices often include a wide variety of electronic devices, such as televisions (TVs), DVD players/recorders, digital video recorders (DVRs), set-top boxes (STBs), and various audio receivers and players. Such electronic devices often can be operated by remote controls that transmit optical or radio frequency (RF) signals to complementary receivers in the electronic devices. Of course, a user having a wide variety of electronic devices also has a wide variety of remote controls, which clutter the user's environment and which can be difficult for the user to remember how to use.

So-called universal remote controls have been developed that can be configured by a user such that one remote control can operate all of the user's devices. Besides the dedicated devices that are commercially available, the increasing popularity of netbook and tablet computers and “smart” phones that include capable programmable digital signal processors suggests them as candidates for universal remote controls.

Although universal remote controls can reduce clutter, they are unavoidably complex devices because of the wide variety of non-standard commands employed by the wide variety of electronic devices. Thus, setting up a universal remote control can be a complicated process that is difficult for even a motivated user. For example, the user may have to arrange the remote control to provide a series of trial signals to each of a user's electronic devices in turn, so that each device's responses train the remote control on which signals belong to which function of which electronic device. Even after being set up, a user can still find it difficult to remember how to use the remote control to operate the user's electronic devices.

Touch-screen devices and more recent multi-touch-screen devices, such as the iPad available from Apple Computer and many other tablet, netbook, and other computers available from many manufacturers, have become increasingly popular and are beginning to be configured as remote controls for user's electronic devices.

User gestures have been used to control electronic devices. For example, U.S. Pat. No. 7,340,077 to Gokturk et al. states that three-dimensional position information obtained with a camera is used to identify the gesture created by a user's body part of interest. At one or more instances of an interval, the posture of a body part is recognized based on the part's shape, position, and orientation. The posture of the body part over the instances is recognized as a combined gesture, and the gesture is classified for determining an input into a related electronic device.

For another example, U.S. Pat. No. 6,191,773 to Maruno et al. states that it relates to an interface apparatus for making input and output of appliances. The interface apparatus includes means for recognizing the shape or move of the hand of an operator, means for displaying the features of the shape or move of the hand recognized as a special shape on a screen, and means for controlling the information displayed on the screen by the special shape. Different user hand shapes or moves can select different user electronic devices.

For another example, U.S. Patent Application Publication No. US 2010/0180298 by Kim et al. states that it relates to a terminal device coupled to a broadcasting receiving apparatus. The terminal device includes a communication unit which receives electronic program guide (EPG) information from the Internet, a display unit that displays EPG information, and a control unit that controls the broadcasting receiving apparatus to perform an operation corresponding to a selection.

A Touch Gesture Reference Guide by C. Villamor et al., available at www.lukew.com, describes gestures used for most touch commands, using gestures to support user actions, visual representations of gestures, and outlines of how popular software platforms support touch gestures.

If a user wants to control a device with gestures, the user first needs to identify the intended device to the remote control, which is to say that the user first has to select the remote control's address context. A user usually selects the address context by pressing a button or icon on a display in the remote control. This can be awkward because the user needs to know or be informed of the address context that the remote control is in, i.e., is the TV or the radio selected now when I want to use the “channel up gesture”?

### SUMMARY

In accordance with aspects of this invention, there is provided a method of selecting and controlling an electronic device by gestures on a remote control. The method includes determining a number of fingers touching a screen of the remote control; based on the number determined, setting an address context corresponding to the electronic device; identifying a gesture made by the fingers on the screen; and based on the gesture identified, generating a corresponding command to be sent to the electronic device corresponding to the set address context.

Also in accordance with aspects of this invention, there is provided a remote control for selecting and controlling an electronic device. The remote control includes a touch-sensitive screen, a programmable digital signal processor in communication with the touch-sensitive screen, and a transmitter in communication with the programmable digital signal processor. The processor is configured to determine a number of fingers touching the touch-sensitive screen, to set based on the number determined an address context corresponding to the electronic device, to identify a gesture made by the fingers on the screen, and to generate based on the gesture identified a corresponding command to be transmitted to the electronic device corresponding to the set address context.

Also in accordance with aspects of this invention, there is provided a computer-readable medium having stored instructions that, when executed by a computer, cause the computer to carry out a method of selecting and controlling an electronic device by gestures on a remote control. The method includes (a) determining a number of fingers touching a screen of the remote control; (b) based on the number determined, setting an address context corresponding to the electronic device; (c) identifying a gesture made by the fingers on the screen; and (d) based on the gesture identified, generating a corresponding command to be sent to the electronic device corresponding to the set address context.

### BRIEF DESCRIPTION OF THE DRAWINGS

The several features, objects, and advantages of this invention will be understood by reading this description in conjunction with the drawings, in which like reference characters indicate like parts and:

FIG. 1 depicts an exemplary arrangement of a remote control and electronic devices;

FIGS. 2A, 2B depict exemplary gestures on a remote control for controlling electronic devices;

FIG. 3 depicts another exemplary gesture on a remote control for controlling electronic devices;

FIG. 4 is a block diagram of a remote control;

FIG. 5 is a flow chart of a method of controlling an electronic device; and

FIG. 6 is a block diagram of an electronic device.

### DETAILED DESCRIPTION

In this description, the term “remote control” means any kind of device that has a touch-sensitive screen and programmable digital signal processor and that is used to control the operation of an other electronic device by sending one or more appropriate commands directly, e.g., by line-of-sight or RF signals, or indirectly, e.g., by wired or wireless Ethernet or other network signals, to the other electronic device.

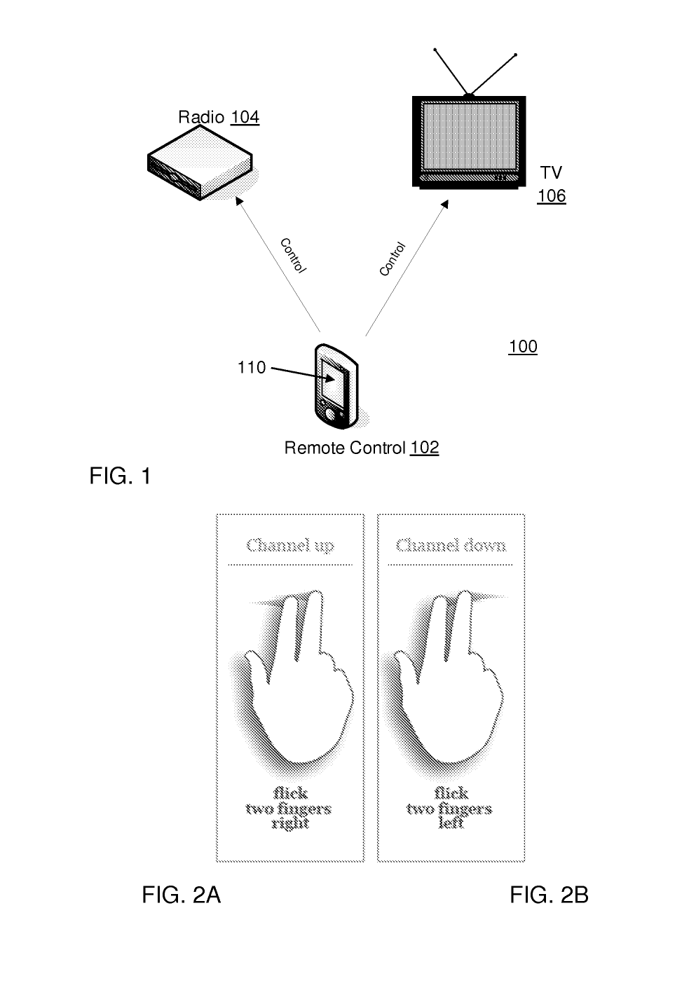

FIG. 1 depicts an exemplary arrangement 100 of a remote control 102 and electronic devices that include a radio 104 and a TV 106. The artisan will understand that many other electronic devices can be included in the arrangement 100. As depicted in FIG. 1, the remote control 102 wirelessly transmits control commands to the devices 104, 106. A user of the remote control 102 indicates a command to be transmitted by a corresponding gesture on a suitable touch- or proximity-sensitive screen 110 of the remote control 102.

For example, the remote control can be configured such that a user's touching the screen 110 with the tip or tips of one or more fingers and flicking, or quickly sliding or swiping, the finger or fingers to the left or right are gestures that change the selected channel on an electronic device 104, 106. A finger flick to the right can be called a “channel up” gesture, and a finger flick to the left can be called a “channel down” gesture. In a similar way, a finger flick upwardly on the screen 110 can be a “volume up” gesture, and a finger flick downwardly on the screen 110 can be a “volume down” gesture. Other finger-tip movements can correspond to other electronic device actions, and the artisan will understand that the actions corresponding to particular finger-tip movements can be varied.

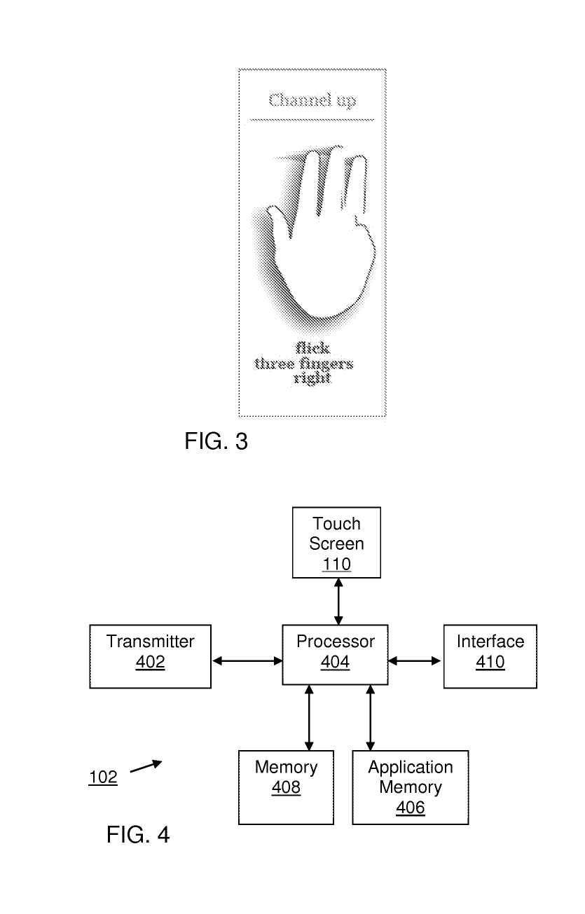

The inventors have recognized that the number of finger tips touching the screen 110 can select the electronic device 104, 106 that the remote control 102 should interact with, enabling the same basic gestures to control the same basic operational functions of any selected device. For example, as depicted in FIG. 2A, a channel-up gesture with two fingers can select the next-higher channel on the TV 106, and as depicted in FIG. 2B, a channel-down gesture with two fingers can select the next-lower channel on the TV 106. In addition, a channel-up gesture with three fingers can select the next-higher channel on the radio 104 as depicted in FIG. 3. For simplicity, gestures with one finger can indicate commands for the remote control 102 itself.

The artisan will understand that correspondences between the numbers of fingers and the remote control and electronic devices can be predetermined or chosen by a user during set up of the arrangement 100. Using a touch-sensitive or equivalent screen and the number of fingers in accordance with this invention is advantageous in that a user can interact with multiple devices via a single remote control using gestures without knowing the remote control's addressing context in advance.

FIG. 4 is a block diagram of a typical remote control 102, such as a smart phone, tablet computer, etc., for controlling electronic devices as described in this application. The remote control 102 includes a transceiver 402 that is suitable for transmitting command signals to the electronic devices 104, 106 depicted in FIG. 1. The command signals are generated by a suitably programmed digital signal processor 404, which may include one or more sub-processors, and which executes one or more software modules and applications to carry out the operations of the remote control 102 described above. User input to the remote control 102 is provided through a touch- or proximity-sensitive screen or pad 110, and information can be presented to the user on the screen 110. Software applications can be stored in a suitable application memory 406, and the remote control can cache desired information in a suitable memory 408. The remote control 102 may also include an interface 410 that can be used to connect the remote control to other components, such as a computer, local or wide area network, etc.

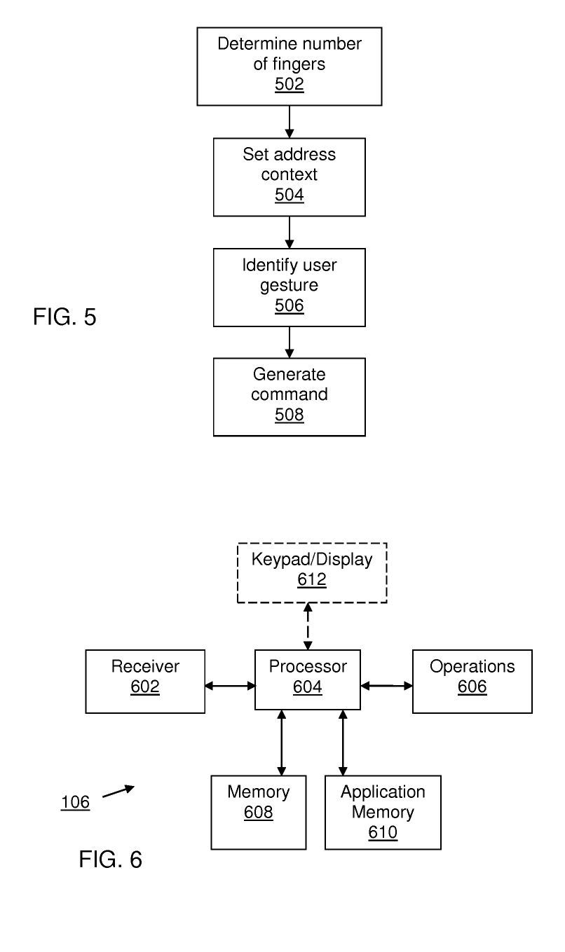

A user inputs a gesture on the touch screen 110 that causes the processor 404, using information in the memories 406, 408, to generate the appropriate control command(s) and transmit the command(s) via the transmitter 402 to the appropriate electronic device 104, 106. Thus, as depicted in FIG. 5, the processor 404 and memories 406, 408 are configured or programmed to determine (step 502) the number of fingers touching the screen 110, and based on the determined number, to set (step 504) the address context of the remote control 102. The processor 404 identifies a gesture made on the screen 110 by the user (step 506), and based on the identified gesture, the processor generates a corresponding command to be sent to the electronic device corresponding to the set address context (step 508). The processor 404 may indicate the transmitted command to the user via the screen 110.

FIG. 6 is a block diagram of a typical electronic device 106 for receiving control commands triggered by user gestures on the remote control 102 as described in this application. The device 106 includes a receiver 602 that is suitable for receiving the command signals transmitted by the remote control 102. Received command signals are handled by a suitable digital signal processor 604, which may include one or more sub-processors, and which executes one or more software modules and applications to carry out the operations of the device 106 described above. In particular, the processor 604 carries out channel and volume changes and other setting adjustments, indicated by operations 506, according to commands received from the remote control 102. The processor 604 can carry out those operations 606 with information stored in a suitable memory 608 and software applications that can be stored in a suitable application memory 610. It will be understood that the electronic device 106 can include a keypad/display 612 for user input/output to the processor 604.

It will be appreciated that procedures described above are carried out repetitively as necessary, for example, to respond to the time-varying nature of communication signals exchanged by transmitters and receivers. Assemblies implementing this invention can be included in, for example, computers, servers, wireless communication network base stations, and the like.

To facilitate understanding, many aspects of this invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

Moreover, this invention can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, or transport the program for use by or in connection with the instruction-execution system, apparatus, or device. The computer-readable medium can be, for example but not limited to, an electronic, magnetic, optical, electromagnetic, infrared, or semiconductor system, apparatus, or device. More specific examples (a non-exhaustive list) of the computer-readable medium include an electrical connection having one or more wires, a portable computer diskette, a random-access memory (RAM), a read-only memory (ROM), and an erasable programmable read-only memory (EPROM or Flash memory).

Thus, the invention may be embodied in many different forms, not all of which are described above, and all such forms are contemplated to be within the scope of the invention.

It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A method of selecting and controlling an electronic device by gestures on a remote control, comprising:
(a) determining a number of fingers touching a screen of the remote control;
(b) based on the number determined, setting an address context corresponding to the electronic device;
(c) identifying a gesture made by the fingers on the screen; and
(d) based on the gesture identified, generating a corresponding command to be sent to the electronic device corresponding to the set address context.

2. The method of claim 1, wherein identifying a gesture made by the fingers on the screen comprises identifying sliding fingers leftwardly or rightwardly.

3. The method of claim 2, wherein the corresponding command includes changing a selected channel on the electronic device.

4. The method of claim 2, wherein the corresponding command includes changing a selected volume level on the electronic device.

5. A remote control for selecting and controlling an electronic device, comprising:
a touch-sensitive screen;
a programmable digital signal processor in communication with the touch-sensitive screen; and
a transmitter in communication with the programmable digital signal processor;
wherein the processor is configured to determine a number of fingers touching the touch-sensitive screen, to set based on the number determined an address context corresponding to the electronic device, to identify a gesture made by the fingers on the screen, and to generate based on the gesture identified a corresponding command to be transmitted to the electronic device corresponding to the set address context.

6. The remote control of claim 5, wherein identifying a gesture made by the fingers on the screen comprises identifying sliding fingers leftwardly or rightwardly.

7. The remote control of claim 6, wherein the corresponding command includes changing a selected channel on the electronic device.

8. The remote control of claim 6, wherein the corresponding command includes changing a selected volume level on the electronic device.

9. A computer-readable medium having stored instructions that, when executed by a computer, cause the computer to carry out a method of selecting and controlling an electronic device by gestures on a remote control, wherein the method comprises:
(a) determining a number of fingers touching a screen of the remote control;
(b) based on the number determined, setting an address context corresponding to the electronic device;
(c) identifying a gesture made by the fingers on the screen; and
(d) based on the gesture identified, generating a corresponding command to be sent to the electronic device corresponding to the set address context.

10. The computer-readable medium of claim 9, wherein identifying a gesture made by the fingers on the screen comprises identifying sliding fingers leftwardly or rightwardly.

11. The computer-readable medium of claim 10, wherein the corresponding command includes changing a selected channel on the electronic device.

12. The computer-readable medium of claim 10, wherein the corresponding command includes changing a selected volume level on the electronic device.
